(19) United States
(12) Patent Application Publication
(10) Pub. No.: US 2023/0290203 A1
(43) Pub. Date: Sep. 14, 2023

(54) METHOD AND DEVICE FOR ACCESS CONTROL OF PERSONS BASED ON A TEMPERATURE MEASUREMENT

(71) Applicant: Mühlbauer GmbH & Co. KG, Roding (DE)

(72) Inventors: Gerhard Niebling, Regensburg (DE); Deepack Kumar, Roding (DE)

(21) Appl. No.: 18/017,255

(22) PCT Filed: Jul. 8, 2021
(86) PCT No.: PCT/EP2021/069032

§ 371 Date: Jan. 20, 2023

(30) Foreign Application Priority Data
Jul. 21, 2020 (DE) 10 2020 119 264.9

(51) Int. Cl. G07C 9/00; G01J 5/52

(52) U.S. Cl. CPC G07C 9/00563; G01J 5/52; G01J 2005/0077

(57) ABSTRACT

A method and device are provided access control of persons. The method includes: detecting by sensor a reference radiation in the infrared, IR, wavelength range using an IR image sensor; and calibrating the IR image sensor as a temperature sensor in relation to the acquired reference radiation used as a standard at the reference temperature. The method also includes acquiring by image sensor at least an area section of a body surface of a person to be controlled and generating thermal image data representing the thermal image of the area section acquired; determining a body temperature of the person; and allowing or denying access of the person to an access-restricted spatial area based on the determined body temperature.

### CROSS-REFERENCE TO RELATED APPLICATIONS

This application is a national phase entry of, and claims priority to, International Application No. PCT/EP2021/069032, filed Jul. 8, 2021, which claims priority to German Application No. DE 10 2020 119 264.9, filed Jul. 21, 2020. The above-mentioned patent applications are incorporated herein by reference in their entirety.

### TECHNICAL FIELD

This application relates to a method and a device for personal access control.

### BACKGROUND

Personal access control devices are used in particular to effectuate access controls to access-restricted rooms or areas, for example in the context of access controls for areas that require a ticket, such as event sites or railway platforms, or for security areas of airports or seaports, industrial plants or power plants or research laboratories, government buildings, or national borders.

Access control is usually based on a person having to be successfully authenticated in order to pass the access control and thus be able to enter the access-restricted spatial area. In this case, the authentication can take place in particular using an ID card, a biometric identification, such as an eye iris recognition or fingerprint recognition, or by a secret password (PIN).

Against the background of the epidemics and even pandemics (e.g., SARS, Covid-19), which have occurred more frequently in recent times, access control systems are also known in which a thermal image of a person to be controlled is recorded using a thermal camera and a body temperature is determined therefrom, which is compared to a temperature threshold in order to recognize based thereon whether the person has an elevated body temperature or fever and is therefore potentially ill, in particular potentially infectious.

Thus, it would be desirable to further improve access controls in which the body temperature of a person to be controlled is checked, in particular to increase the accuracy and/or freedom from errors achievable in this case.

### SUMMARY

To address these and other problems with conventional devices and methods, a method for personal access control is provided according to a first set of embodiments. The method includes: (i) acquiring by sensor a reference radiation in the infrared, IR, wavelength range of the electromagnetic spectrum, which was emitted by a thermal reference radiation source, which in particular can at least approximately be a blackbody radiator, at a known reference temperature, using an IR image sensor; (ii) calibrating the IR image sensor as a temperature sensor in relation to the acquired reference radiation used as a standard at the reference temperature; (iii) acquiring by image sensor at least an area section of a body surface of a person to be controlled, in particular their face or a part thereof, in the infrared wavelength range by the IR image sensor and generating thermal image data representing the thermal image of the area section acquired in this case; (iv) determining a body temperature of the person associated with the area section on the basis of the thermal image data and taking into consideration the calibration; and (v) allowing or denying access of the person to an access-restricted spatial area in dependence on the determined body temperature.

A “black body radiator” in the meaning of the invention is to be understood as a body that emits electromagnetic radiation as thermal radiation, the intensity and spectral distribution of which is at least largely independent of the other characteristics of the body and its surface and depends only, or at least predominantly, on its temperature. In particular, bodies that at least essentially completely absorb all incident electromagnetic radiation of any wavelength (>90% absorption rate) have the above-mentioned properties and are therefore blackbody radiators.

“Infrared radiation”, IR, or “infrared wavelength range” and modifications of these terms are to be understood as the spectral range within the electromagnetic spectrum between visible light and longer-wave terahertz radiation. This includes in particular the wavelength range from 780 nm to 1 mm.

An “IR image sensor” in the meaning of the invention is to be understood as an image sensor, in particular a camera, which is capable of recording an image (thermal image) in the infrared wavelength range and providing corresponding thermal image data. In particular, a thermal camera is an IR image sensor in the meaning of the invention.

As possibly used herein, the terms “comprises,” “contains,” “involves,” “includes,” “has,” “having,” or any other variant thereof are intended to cover non-exclusive inclusion. For example, a method or a device that comprises or includes a list of elements is not necessarily restricted to these elements, but may involve other elements that are not expressly listed or that are inherent to such a method or device.

Furthermore, unless expressly stated to the contrary, “or” refers to an inclusive or and not to an exclusive “or”. For example, a condition A or B is met by one of the following conditions: A is true (or present) and B is false (or absent), A is false (or absent) and B is true (or present), and both A and B are true (or present).

The terms “a” or “an” as possibly used herein, are defined in the meaning of “a/one or more”. The terms “another” and “a further” and any other variant thereof are to be understood to mean “at least one other”.

The term “plurality” as possibly used herein is to be understood to mean “two or more”.

Various advantages can be implemented with the aid of the above-mentioned method. In particular, with the aid of the calibration, the accuracy and thus also the freedom from error of the body temperature-dependent granting or denying of access can be increased or an occurring error rate can be reduced, in particular minimized. In some tests, for example, and without this being understood as a restriction, it has already been possible to achieve a high level of accuracy of up to approximately ±0.2° C. Due to the use of the thermal image acquired by sensor, the method is also capable of distinguishing a living real person from a mere image of a person, such as a photo or an image display or video display on a display screen (for example a mobile phone or tablet computer) based on temperature.

Preferred embodiments of the method are described hereinafter, which in each case, unless expressly excluded or technically impossible, can be combined as desired with one another and with the further described other embodiments of the invention.

In some embodiments, the decision to grant or deny access is made in dependence on the determined body temperature of the person by checking the body temperature itself or a variable derived and dependent therefrom using an assigned access criterion. For example, such an access criterion can be defined by a temperature threshold, so that access is denied, in particular independently of any further access criteria or tests, if the determined body temperature is above this temperature threshold.

In some embodiments, the method furthermore includes: (i) acquiring by image sensor the at least one area section in the visible wavelength range and generating image data representing the image of the area section acquired in the process; and (ii) detecting at least one biometric feature of the person by the image data. The granting or denying of the access of the person to the access-restricted spatial area also takes place in dependence on the at least one determined biometric feature, for example in dependence on a result of biometric facial recognition. Thus, granting or denying access depending on body temperature can be combined with biometric access control, in particular in such a way that access is only granted if the body temperature meets a corresponding access criterion, in particular falls below a corresponding temperature threshold, and at the same time successful authentication and access authorization based on the at least one biometric feature has taken place. In this way, health protection on the one hand and other personal security aspects on the other hand can be addressed in combination in the context of access control. The result of the body temperature determination can thus also be specifically assigned to the authenticated person, in order to be able to initiate a medical examination or treatment of this person in a targeted manner.

In some embodiments, the method furthermore includes: (i) identifying two or more partial areas in the area section based on the at least one biometric feature as respective images of certain respective body surface sections of the person; (ii) assigning a respective local body temperature of the person to each of these partial areas on the basis of the thermal image data and taking into consideration the calibration; (iii) comparing at least two of the respective local body temperatures to one another or to a respective assigned temperature standard for the respective body surface sections. The granting or denying of the access of the person to the access-restricted spatial area additionally takes place in dependence on whether the comparison result(s) meet(s) an access criterion assigned to the comparison(s). The partial areas can relate, for example, to specific parts of the face, such as left cheek, right cheek, nose, eye area, forehead, chin, etc. With the aid of these embodiments, not only one overall body temperature assigned to the person, but also a plurality of local body temperatures assigned to the respective partial areas can be determined and used for the purpose of a plausibility check. For example, the plausibility check could comprise comparing the respective local temperatures of the two cheeks to one another, and the associated access criterion could be defined in such a way that if these two local temperatures deviate from one another beyond a certain temperature threshold, a measurement error is concluded and access is therefore denied. In another example, one or more of the local temperatures could each be compared to assigned temperature standards, i.e., reference temperatures for the assigned partial areas, for the purpose of a plausibility check and access can be granted or denied, in particular in dependence on the result of this plausibility check.

In some embodiments, the body temperature of the person assigned to the area section is determined on the basis of the thermal image data and in consideration of the calibration in such a way that only the respective temperature values of one or more partial areas of the area section from the thermal image are selectively used for this purpose, in which the partial areas or their temperature values or both correspond to a predetermined selection criterion. The selection criterion can, for example, correspond to a filter for specific partial areas. In particular, it can be defined such that only the local temperature value of a single specific partial area, such as the forehead, the chin, or a cheek, is selectively used from the thermal image to determine the body temperature, while the corresponding local temperatures of other partial areas are not taken into consideration. Alternatively or additionally, the selection criterion can also be defined in such a way that it is defined by applying the criterion to the different local temperatures of the partial areas which of these local temperatures are used to determine the body temperature of the person. For example, the selection criterion can be defined in such a way that only the n highest local temperature values among the N temperature values of the N partial areas are used to determine the body temperature of the person, wherein n=1, 2, . . . , N−1. In this way, the accuracy and reliability can be further increased, since lower temperature values that are less relevant for determining a maximum body temperature, which is particularly relevant for fever detection, can be suppressed.

In some embodiments, the method furthermore includes: (i) determining the image area proportion within the image represented by the image data of the total area of the image that images a predetermined selected body surface section of the person; (ii) checking whether the image area proportion corresponds to an image area proportion criterion which, directly or indirectly via a dependent variable, specifies a minimum required image area; and (iii) if, according to the test, the image area proportion does not meet the image area criterion, denying the access of the person to the access-restricted spatial area. In this way, the accuracy and reliability of the method can be further increased, since granting access on the basis of a temperature determination with regard to an image area proportion that is too small, for which a sufficiently precise temperature determination would be difficult or impossible due to its small area, is avoided.

In some embodiments, the method furthermore includes: correcting the perspective of the image of the surface area represented by the image data before the at least one biometric feature of the person is detected on the basis of the image that is then corrected in perspective. The accuracy and reliability of the method can also be further increased in this way, since the decision about granting access, insofar as it is based on the at least one biometric feature, can be made on the basis of a image corrected in perspective, which is generally better suitable for reliable identification or authentication of a person image therein than an original image distorted in perspective.

In some embodiments, if access is denied, one or more of the following reactions is triggered: (i) an acoustic alarm, particularly by speech output, or a visual alarm; (ii) a physical block of access to the access-restricted spatial area, in particular by a barrier or door; (iii) sending a signal or message to a predetermined recipient to notify of the denial of access; (iv) generating a physical access token, such as a ticket, having an encrypted message to a predetermined recipient notifying that access has been denied. In the case of option (iii), the recipient can in particular be a mobile terminal, such as that of a supervisor. In this way, signaling even over a greater distance and/or discrete signaling can be achieved. The latter can in particular also help prevent the occurrence of panic or other undesirable reactions from other people. In the case of option (iv), in particular, an access token in the form of an access ticket (such as a type of paper receipt) having an encrypted/coded message can be printed out at a predetermined recipient to notify denial of access or otherwise granting of access. This ticket is later shown to the recipient (for example a customs officer or an access control device) to be checked. Only the recipient knows the various possible codes of the messages and thus whether a specific code on a ticket indicates a denial or grant of access or an unsafe measurement that indicates a re-check of body temperature or other potential signs of illness, and can ultimately grant or deny access on the basis of this information. This variant can be used in particular in the context of an embodiment in which the method is carried out by a correspondingly configured device, which is in the form of a kiosk (cf. FIG. 4). Instead of a ticket, other types of access tokens, such as magnetically or otherwise wirelessly encoded chip cards or radio transponders, are also possible.

In a second set of embodiments of the invention, a device for personal access control is provided, which is configured to carry out the method according to the above-mentioned embodiments. The statements made here on the method thus apply similarly to the device according to the second set of embodiments.

Preferred embodiments of the device are described hereinafter, which in each case, unless expressly excluded or technically impossible, can be combined as desired with one another and with the first set of embodiments of the invention.

In some embodiments, the device includes: (i) an IR image sensor for acquiring by image sensor radiation in the infrared, IR, wavelength range of the electromagnetic spectrum and for generating thermal image data representing the thermal image acquired in this case; (ii) a reference radiation source for emitting an at least partially infrared reference radiation, provided as a standard for a calibration of the IR image sensor as a temperature sensor, at a known reference temperature of the reference radiation source; (iii) an access control device for signaling or effectuating a grant or denial of the access of the person to the access-restricted spatial area; and (iv) a controller, in particular a data processing device, which is configured: (iv-1) to carry out the calibration of the IR image sensor as a temperature sensor with respect to the detected reference radiation serving as a standard at the reference temperature; (iv-2) to determine a body temperature for an area section of a body surface of the person to be checked, represented by the thermal image data, in consideration of the calibration; and (iv-3) to activate the access control device in order to grant or deny the person access to the access-restricted spatial area in dependence on the determined body temperature. The access control device and the controller can in particular also coincide and thus form a common unit. In the case of the above-mentioned variant in which a ticket is generated, the access control device can in particular have a production device for generating the ticket, such as a printing device, in particular for printing ticket blanks. This variant can be used in particular in the context of an embodiment of the device in which it is in the form of a kiosk (cf. FIG. 4).

In some embodiments, the device furthermore includes a VIS image sensor for acquiring by image sensor the at least one area section in the visible wavelength range, VIS, and for generating image data representing the image of the area section acquired in this case, wherein the device is configured to carry out the method according to the first set of embodiments of the invention using the VIS image sensor. In particular, the access of the person to the access-restricted spatial area can additionally be granted or denied in dependence on one or more biometric features determined using the image data, in particular in accordance with the manner explained above in the context of the description of the method.

In some embodiments, the device also has a thermocouple for determining by sensor the reference temperature of the reference radiation source. This is preferably a high-precision temperature sensor, the measuring accuracy of which for temperature measurements corresponds at least to that of the IR image sensor. In this way, the calibration can always take place at a currently measured reference temperature that actually exists, and the accuracy of the method or the device with regard to carrying out the method can be further increased. In particular, the accuracy can thus be maintained independently of any temperature fluctuations of the reference radiation source.

In some embodiments, the IR image sensor or, if present, the VIS image sensor is configured in such a way that its respective position, orientation, or focus is variably adjustable in order to be able to vary the image detail that can be acquired by the respective image sensor. In this way, the body temperature of the person can be determined with comparable accuracy at various positions of the person in relation to the image sensor(s), since these can be configured according to their respective relative position to the person or the area section on their body surface. It is also possible to take into consideration the height or other constitution of the person, such as whether they are standing or sitting in a wheelchair, for example. In particular, the device can thus also be designed to be particularly suitable for the disabled and reliably carry out temperature measurements on people of greatly varying body sizes.

In some embodiments, the reference radiation source is arranged in the same housing as the IR image sensor. In addition, the field of view of the IR image sensor has a partial field of view area that is located inside the housing and is not intended for the detection of IR radiation incident from outside the housing. A deflection mirror for IR radiation is arranged in the partial field of view, which is configured to deflect reference radiation emitted by the reference radiation source into the field of view of the IR image sensor, in order to thus enable acquiring by sensor the reference radiation by the IR image sensor in the partial field of view. The deflection mirror can in particular include a mirror surface made of aluminum or polished stainless steel. These embodiments advantageously offer the possibility of dispensing with an external reference radiation source. On the one hand, this enables particularly compact designs and, on the other hand, avoids the risk that the beam path between the IR image sensor and the reference radiation source could be interrupted, in particular by the person to be controlled himself. Since the reference radiation in the field of view of the IR image sensor is deflected out of a partial field of view to the IR image sensor that is not within the external field of view of the IR sensor and is therefore not within the thermal image of the person to be acquired, overlaps and unwanted interactions can be avoided between the acquisition of the thermal image of the person on the one hand and the acquisition of the reference radiation on the other hand. In particular, it is possible to configure the IR image sensor in such a way that the acquisition of the reference radiation and of the thermal image of the person takes place simultaneously or independently of one another, wherein the two types of acquisition can be separated and further processed independently of one another due to the different directions in the field of view from which the respective radiation is incident on the IR image sensor.

In some embodiments, the access control device has a personnel airlock in which access to the access-restricted spatial area is granted or denied in dependence on the determined body temperature. In many cases, personnel airlocks have a lockable spatial area in which the processing, in particular authentication, of a person to be guided through takes place. The spatial area can be locked in particular by one or more, in particular by two doors or pairs of doors, wherein one door or a pair of doors is usually provided as a lockable entry and a further door or a further pair of doors is provided as a lockable exit from the spatial area. In these cases, if permissible, due to the lockability of the spatial area, in particular the temporary further availability of a person who was recognized as a potentially ill or infected person during the control according to the method or who was recognized as not access-authorized for another reason can thus be ensured for further tests or measures. Individuals to be controlled can also be isolated in this way, as a result of which the probability of errors occurring during the personal control due to the simultaneous acquisition of two or more people instead of a single person can be reduced or minimized.

In some of these embodiments, the reference radiation source is arranged at a first position on the personnel airlock. The IR image sensor is arranged in a second position, opposite to the first position with respect to the interior of the personnel airlock, in such a way that the beam path of the reference radiation source is at least partially in the field of view of the IR image sensor such that it does not cross a spatial area provided for accommodating the person to be controlled in the personnel airlock. These embodiments also permit reliable calibration in those cases in which the reference radiation source is not designed as a unit with the IR image sensor, in particular is not located in the same housing. In order to enable a beam path that cannot easily be crossed by the person to be controlled in the personnel airlock, one or more mirrors or other optical deflection elements can be provided in particular, which deflect the beam path of the reference radiation around the spatial area provided for accommodating the person in the personnel airlock. In particular, it is again also possible in these embodiments to configure the IR image sensor in such a way that the acquisition of the reference radiation and of the thermal image of the person takes place simultaneously or independently of one another, wherein the two types of acquisition can be separated and further processed independently of one another due to the different directions in the field of view from which the respective radiation is incident on the IR image sensor.

In some embodiments, which in particular can manage without a personnel airlock, the access control device has a coding device for generating a coded access token. Depending on the determined body temperature, the code indicates whether access to the access-restricted spatial area is granted or denied. The coding device can in particular have a printing device for printing a ticket, for example in the form of a paper receipt, having the code and optionally other information. Depending on the code, access can then be granted or denied. In particular, such an embodiment allows the location of the body temperature measurement to be spatially separated from the location at which access is granted or denied, for example in the sense of an opening or closing of a physical access barrier or a signaling, for example in the form of a traffic signal. In particular, it is possible in this way to subject a number of people to a body temperature measurement at different measurement stations at the same time, even if there is only a small number of accesses, in particular only a single access, to the access-restricted spatial area.

### BRIEF DESCRIPTION OF THE DRAWINGS

The accompanying drawings, which are incorporated in and constitute a part of this specification, illustrate one or more embodiments of the invention and, together with the general description given above and the detailed description given below, explain the one or more embodiments of the invention.

FIG. 1 schematically shows, in a top view, an exemplary illustration of a device for access control of persons according to an embodiment of the invention.

FIG. 2 schematically shows an exemplary illustration of an IR image sensor having an integrated reference radiation source.

FIGS. 3A and 3B show a flowchart to illustrate a preferred embodiment of the method according to the invention.

FIG. 4 shows a device in the form of a kiosk for access control of persons according to a further embodiment of the invention.

### DETAILED DESCRIPTION

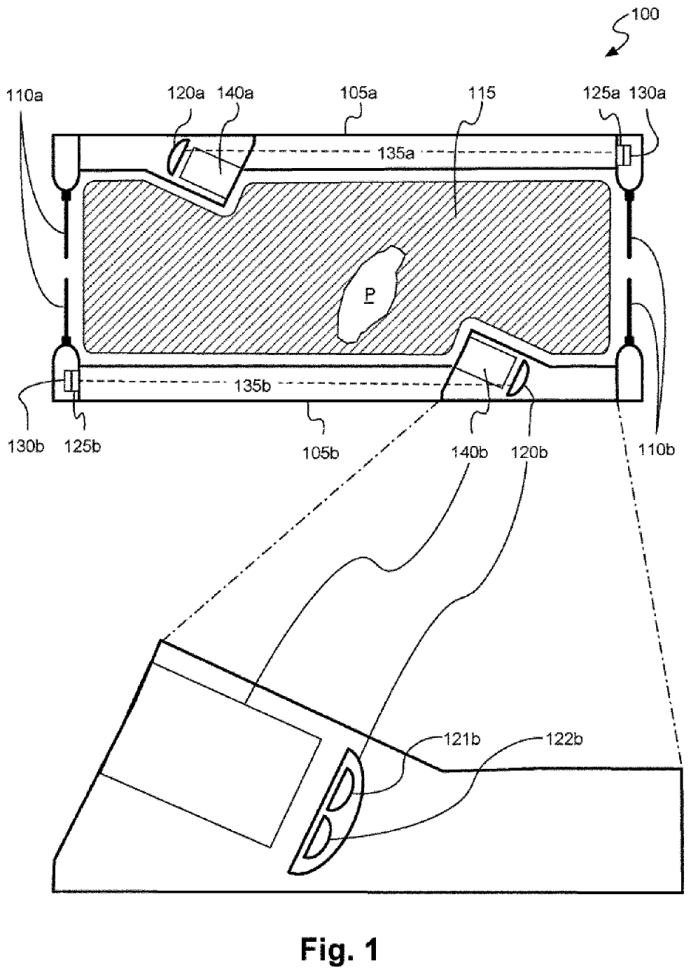

The exemplary device 100 for access control of persons illustrated in FIG. 1 (upper part) includes a bidirectionally usable personnel airlock, which includes two opposing parallel side walls 105a and 105b and physical access restrictions in the form of a pair of doors 110a and 110b on each of their front sides. The doors of the pairs of doors 110a,b can in particular be designed as swinging doors, as shown. Alternatively or additionally to the pairs of doors 110a, b, any other type of physical access restriction can also be provided, for example a barrier in each case. Alternatively or additionally to physical access restrictions, signaling can also be provided that signals whether the access is free or blocked. For example, a light source, such as a type of traffic signal, or an acoustic signal can be provided for this purpose.

The side walls 105a,b and the pairs of doors 110a,b define a spatial area 115 in the interior of the personnel airlock, which is intended to accommodate a person P to be controlled during the control and to be used as a passage area into an access-restricted spatial area secured by the device 100. Since the exemplary personnel airlock is usable bidirectionally, it can be used to secure both the entry and the exit from the access-restricted spatial area.

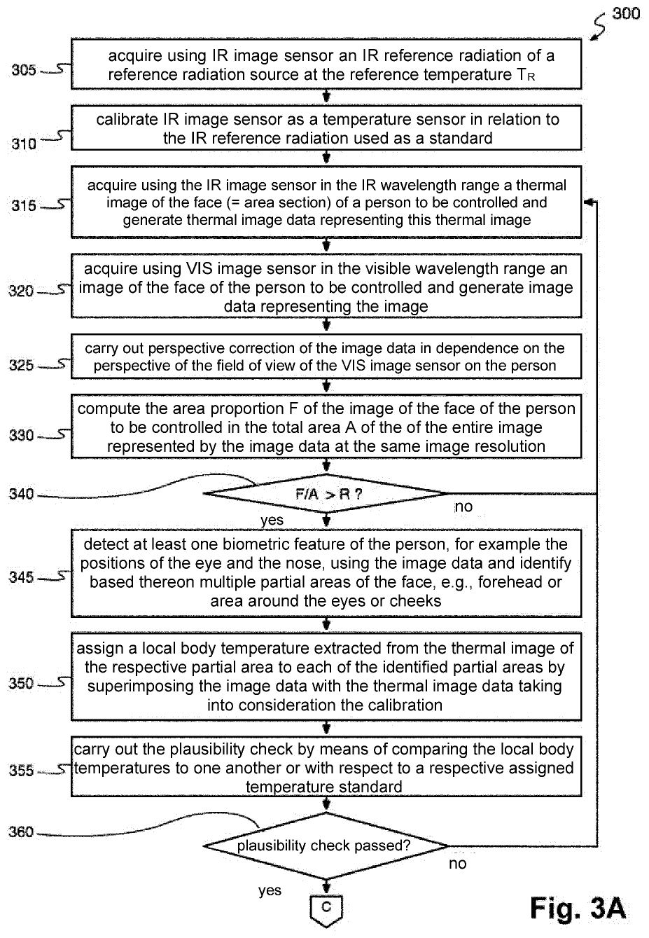

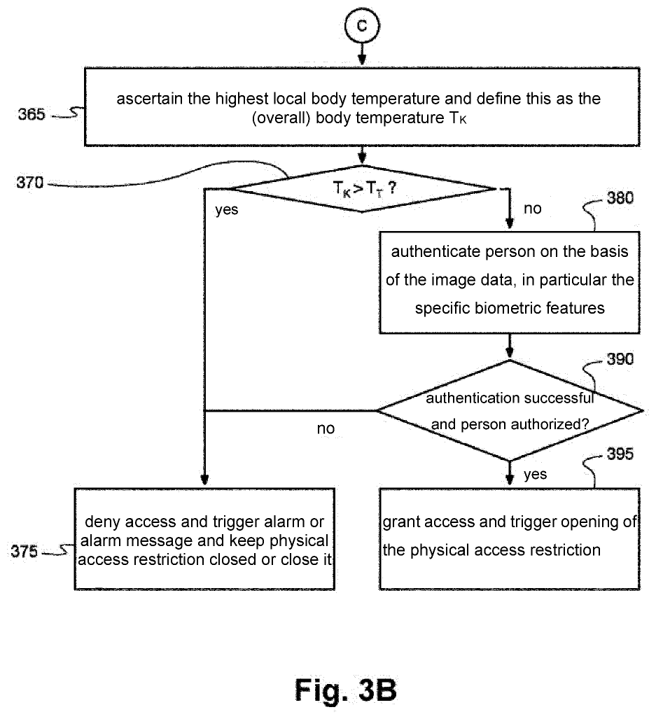

In the following, unless otherwise described, it is assumed for the purpose of explanation (in particular of FIG. 3) that the access-restricted spatial area (not shown) in FIG. 1 is on the right side of the personnel airlock, so that the device 100 is to be passed from left to right to enter the access-restricted spatial area.

In this case, the pair of doors 110a is used as an entrance to the personnel airlock and in particular has the purpose of isolating people, in order to allow a single person at a time to enter the spatial area 115 for control by corresponding brief opening, ideally combined with a subsequent sensory control of the number of persons present at the same time in the spatial area 115, and to block access for other persons for as long as the person P is in the spatial area 115 for control.

In the following it is assumed that the access control takes place with regard to two control aspects, namely on the one hand an authentication of the person P, so that only authorized persons can pass the device 100, and on the other hand a measurement of the body temperature of the respective person to be controlled in order to detect a possibly elevated temperature (fever) and to only let people pass whose body temperature T_{K} is not classified as elevated temperature or fever according to a temperature criterion TT.

The authentication can take place in various ways, for example by facial recognition, fingerprint recognition, PIN input, iris scan, or other known authentication methods. Multiple such authentication methods can also be combined. The device 100 includes appropriate sensors and/or user interfaces (for example for entering a PIN) for carrying out the authentication and a controller 140a, b for each passage direction. The controllers 140a, b for the two passage directions can also be combined in a single controller. In addition, the sensors or the user interfaces, or both, can be combined with the respective controller 140a,b as a unit. The controllers 140a,b are used for the, in particular computer program-based, control of the device 100, in particular when carrying out the method according to the invention, for example according to FIG. 3.

The device 100 also includes an image sensor 120a or 120b for each passage direction. As shown enlarged in the lower part of FIG. 1, each of these image sensors 120a,b includes an IR image sensor 121a or 121b for recording thermal images in the infrared wavelength range (IR) and a VIS image sensor 122a or 122b for recording images in the visible wavelength range (VIS). The IR and VIS image sensors can optionally (i)—as shown in FIG. 1—be housed together in a common housing or also (ii) separately, in particular in separate housings. The image sensors 120a,b are aligned in such a way that the field of view of the respective image sensors 121a,b and 122a,b is directed into the spatial area 115 in order to be able to record a respective image of a person P present in this spatial area 115, at least when the person is positioned in front of and facing toward the corresponding image sensor 120a or 120b. The relative arrangement of the respective IR image sensor 121a,b and the associated VIS image sensor 122a,b is known to the respective controller 140a,b or the image sensors 120a,b itself, so that a perspective image correction can be carried out on the basis of this information in order to be able to compute an undistorted, perspective-adapted superposition of the respective images supplied by the IR image sensor 121a or 121b and its respectively associated VIS image sensor 122 or 122b.

In the field of view of each of the IR image sensors 121a and 121b, a reference radiation source 125a and 125b is provided on the personnel airlock, which is used to supply a standard for calibrating the respective IR image sensor (in particular its sensor signal evaluation). The reference radiation sources 125a,b are preferably designed at least approximately as blackbody radiators, so that the infrared reference radiation they emit is at least largely independent in terms of its intensity and spectral distribution of the further properties of the reference radiation source and its surface and only, or at least predominantly, depends on its temperature. If the temperature of the reference radiation source is known, the intensity and the spectral distribution of the reference radiation emitted by it are therefore also known. To measure its respective current temperature, each of the reference radiation sources 125a, b includes a thermocouple 130a or 130b, which is able to measure the current temperature of the associated reference radiation source 125a, b, ideally with a degree of accuracy <1° C., and to transmit this to the associated controller 140a, b or the associated IR image sensor 121a, b for the purpose of calibration.

The respective beam path 135a,b of the reference radiation is guided within the device 100 in such a way that it does not cross the spatial area 115, so that an interruption of the beam path by a person P to be controlled in the spatial area 115 is unlikely or even impossible.

The image sensors 120a, b can be made configurable in such a way that their respective position, orientation, or focus are variably adjustable, in order to be able to vary the image detail that can be acquired by the respective image sensor. The configurability is implemented in such a way that at each position, orientation, or each focus, the reference radiation for the purpose of calibration is at least temporarily in the field of view of the associated IR image sensor 121a or 121b during the calibration process.

In particular, the housing in which the two sensors 121a and 122a or 121b and 122b are arranged (cf. image sensors 120a,b in FIG. 1) can be inclination-adjustable and/or rotatable and/or vertically-adjustable. The adjustability can in particular be automated, depending on the position or size of the person P. The camera is then, for example, able to recognize whether the person P is not in the image detail or only partially in the image (for example in the case of smaller people). An automatic adjustment then takes place accordingly in order to optimally align the image detail with the person P to be acquired by the image sensor. It is also conceivable that each sensor (IR and VIS) 121a and 122a or 121b and 122b is respectively arranged in its own movable housing. The controller (140a,b in FIG. 1) that may include a user interface can also be designed to be vertically-adjustable, in particular as a complete unit (i.e., including the two sensors 121a and 122a or 121b and 122b), in particular in the manner of a lift that moves the entire unit vertically.

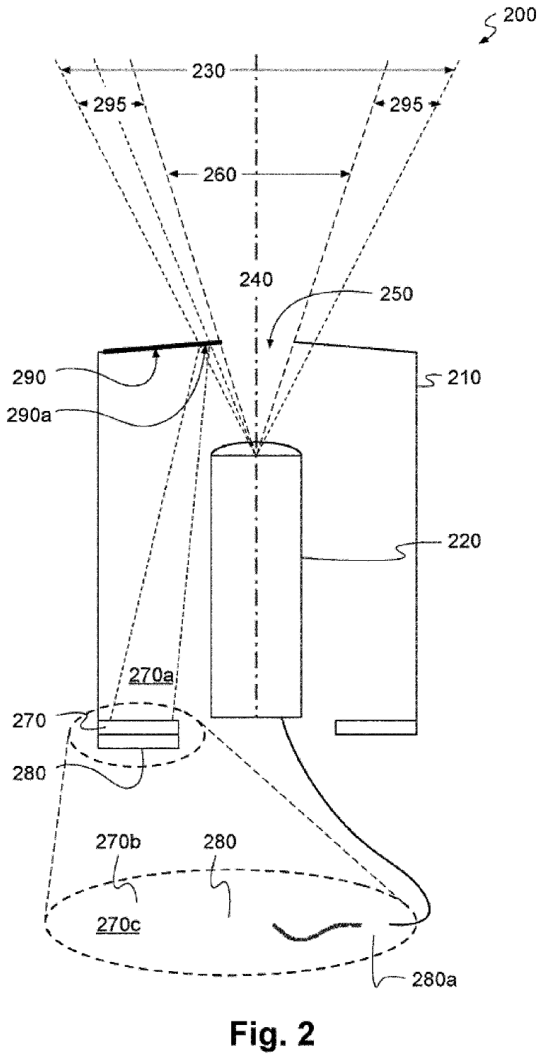

FIG. 2 shows an embodiment 200 of an IR image sensor device, in particular for the device 100, in which, unlike the variant described in FIG. 1, a reference radiation source 270 is already integrated in the same housing 210 with an IR image sensor 220 as a unit.

In this case, the IR image sensor 220 has a maximum field of view 230, which typically has a conical or three-dimensional contour centered around the optical access 240 of the IR image sensor 220. In the housing 210 there is a housing opening 250 which is used as a viewing opening of the IR image sensor 220 into its external field of view 260 which is delimited by the housing opening 250 and which represents a partial area of the maximum field of view 230.

In addition, a reference radiation source 270 for IR radiation, for example a heatable metal plate, is located in the housing 210. The reference radiation source 270 is preferably designed at least approximately as a black body radiator. Furthermore, a thermocouple 280 is provided on (cf. FIG. 2 main part top) or in (cf. FIG. 2 section at the lower end of the figure) the reference radiation source 270 in order to measure the respective current temperature of the reference radiation source 270 as a reference temperature in accordance with the explanations already given for FIG. 1. The detail in the lower part of FIG. 2 illustrates an exemplary embodiment of a combination of reference radiation source 270 and thermocouple 280 that is an alternative to that in the upper main part of the figure. Here, the reference radiation source 270 has a heating block 270c optionally provided with a heater, which can in particular be a metal block and acts as a heat source or heat buffer. A layer 270b, in particular as a coating, which acts as a blackbody radiator, is dark, and essentially does not reflect light or only slightly reflects light, is provided on the heating block 270c, which can be supplied with heat by the heating block 270c and typically assumes its temperature. In the heating block 270c, the thermocouple 280 is arranged, at least in sections, in a cavity thereof, due to which a direct and thus particularly precise and reliable temperature measurement of the temperature of the heating block and thus of the reference radiation source 270 as a whole can be achieved. It is preferably a high-precision thermocouple (PT 100). In particular for the purpose of optimal heat conduction, it can be embedded in the cavity of the heating block 270c using a temperature contact paste. A measurement signal output of the thermocouple 280 is connected to a signal converter 280a, which itself can also be designed as part of the thermocouple 280 and which is configured to convert the measurement signal of the thermocouple 280 into a signal suitable for further processing by the IR image sensor, which represents the measured temperature of the reference radiation source 270 or a dependent variable derived therefrom. This signal thus assigns the measured temperature as reference temperature T_{R} for the purpose of calibrating the radiation of the reference radiation source.

In the embodiment 200 shown in FIG. 2, the reference radiation source 270 is not itself arranged in the field of view of the IR image sensor 220. Instead, a deflection mirror 290 is provided on the inner wall of the housing 210, which in particular can include a polished metal surface, for example a polished stainless steel surface. This surface of the mirror 290 can be provided in addition to the housing wall or can already be formed by the inside of the housing wall of the housing 210 itself.

The relative position and orientation of the reference radiation source 270 and the deflection mirror 290 are provided in such a way that the beam path 270a for IR radiation originating from the reference radiation source 270 is imaged at least partially in the maximum field of view 230 of the IR image sensor 220 by the deflection mirror 290, so that it can acquire the reference radiation reflected by the deflection mirror 290 using an image sensor. It is advantageous if the arrangement of the reference radiation source 270 and the deflection mirror 290 is selected such that the reference radiation reflected by the deflection mirror 290 is in the maximum field of view 230 of the image sensor 220, but not in its limited external field of view 260, but in a partial field of view area 295 lying outside of the limited external field of view 260. Thus, the reference radiation can be received without being superimposed on the thermal image acquired from the external field of view 260 and can be evaluated uninfluenced by it, at least essentially. The embodiment 200 thus represents a particularly compact and reliable option for implementing the IR image sensor. In particular, no beam path external to the housing is required for the reference radiation.

An exemplary embodiment of a method 300 according to the invention for personal access control is illustrated in the two associated FIGS. 3A and 3B, which overall show a flow chart and are graphically connected by a “connector” C. For purposes of explanation, the method 300 is described below with exemplary, non-limiting reference to FIG. 1 and in the passage from left to right therein, however, this should not be construed as a restriction. If the passage direction is reversed, the method proceeds accordingly, wherein then the elements of the device 100 marked with “a”, in particular the controller 140a and the image sensor 120a, are used.

The method 300 includes a step 305 in which an infrared reference radiation 135b emitted by the reference radiation source 125b at the current temperature T_{R} is acquired by sensor with the aid of the IR image sensor 121b. The current temperature T_{R} can in particular be measured using the thermocouple 130b. Then, in a further step 310, the IR image sensor 121b is calibrated with respect to the reference radiation 135b used as a calibration standard. In the context of the calibration, based on the measured temperature T_{R} and the acquired reference radiation 135b, the IR image sensor 121b, or an evaluation unit assigned thereto, in particular evaluation electronics or evaluation software, is configured in such a way that further temperature measurements based on a thermal image recorded by the IR image sensor 121b of the reference radiation 135b emitted at the reference temperature T_{R} supply the actual temperature T_{R} within the scope of the measurement accuracy. The evaluation unit can be formed in particular by the controller 140b.

After the calibration has taken place, the device 100 is ready for use to carry out a personal access control. If a person P to be controlled is in the spatial area 115 of the device 100 after passing through the access opening of the personnel airlock closable by the pair of doors 110a, they are prompted, for example by a corresponding display on a graphical user interface or via a speech output, to turn to the image sensor 120b, in order to be acquired by an image sensor.

Then, in step 315, a thermal image of the face of the person P is recorded using the IR image sensor 121b and corresponding thermal image data representing the thermal image are generated. At the same time, in a step 320, an image of the face of the person P in the visible wavelength range (VIS) is acquired by an image sensor by the VIS image sensor 122b, and image data representing the image are generated. In order to be able to superimpose the thermal image and the image without errors, a perspective correction of the image data and/or of the thermal image data is now carried out in a step 325, so that the thermal image and the VIS image correspond to the same perspective of the person P after the correction. In this case, the correction takes place on the basis of the previously known relative location and position of the two image sensors 121b and 122b in relation to one another.

In order to ensure a sufficiently high level of reliability for the fever detection and an authentication to be carried out on the basis of biometric face recognition, moreover, in a step 330, the area proportion F of the image of the face relative to the total area A of the entire image represented by the image data (at same image resolution) is computed on the basis of the image data.

If a subsequent test in step 340 reveals that the ratio F/A is not above a certain image area proportion criterion R (340—no), it is assumed that the face is not represented sufficiently large in the image to ensure the further method 300 proceeds correctly with regard to the correctness of the decision to be made regarding the granting or denying access of the person P to the access-restricted spatial area secured by the device 100. A jump is therefore made back to step 315 in order to carry out another image acquisition.

Otherwise (340—yes), the method continues with a step 345, in which at least one biometric feature of the person P, for example the positions of the eyes and the nose, is first detected and measured based on the image data. Based on this, multiple partial areas of the face are identified in the image, for example the forehead or the area around the eyes or the cheeks of the person P.

By superimposing the image according to the image data and the thermal image according to the thermal image data, a local body temperature taken from the corresponding image area of the thermal image can now be assigned in a step 350 to each of the identified partial areas. For example, the maximum temperature occurring in its associated image area of the thermal image can be determined as the associated local body temperature for each partial area. Alternatively, for example, an average temperature over the image area of the thermal image that corresponds to the partial area can also be determined as the local body temperature of the partial area.

As a further security measure to increase the reliability of the method, a plausibility check can be carried out in a step 355, in which the local body temperatures for the different partial areas are compared to one another or in each case to an associated predetermined temperature standard. Such a temperature standard can exist, for example, in the form of data determined on the basis of statistical surveys. Certain plausibility criteria, which can also be determined on a statistical basis, are also defined for a relative comparison of the local body temperatures to one another, in order to be able to determine whether any temperature differences between the respective determined local body temperatures for different partial areas of the face are within a typical range, or due to a deviation therefrom indicate an increased probability of a measurement error.

In dependence on the result of the plausibility check, a jump is then made back to step 315 in a step 360 if the plausibility check was not passed (360—no). Otherwise (360—yes), an overall body temperature T_{K} of the person P is ascertained on the basis of the local body temperatures determined for the various partial areas, which have now been checked for plausibility. In particular, this can be done in such a way that the highest of the local body temperatures is determined as the overall body temperature T_{K} (selection criterion). However, other variants of selection criteria are also conceivable here, in particular an averaging, which is weighted in particular, over the various local body temperatures or a selection of a subset of the local temperatures with subsequent averaging over them.

In a step 370 it is now checked whether the overall body temperature T_{K} is above a predetermined temperature threshold TT which defines an access criterion in the form of a criterion for an elevated body temperature. If this is the case (370—yes), then in a step 375 access is denied and an alarm or a discrete alarm message is optionally triggered to the terminal of a predetermined recipient, for example a security guard. The physical access restriction to the access-restricted spatial area provided in the form of the pair of doors 110b remains or is (if not already closed) closed.

Otherwise (370—no), the person is also authenticated on the basis of the image data acquired by the image sensor 122b, for which purpose in particular the same biometric features can be used that were already previously used to determine the partial areas of the image of the face. If the authentication is successful and it has the result that the person P is authorized to access the access-restricted spatial area (390—yes), a step 390 branches to step 395, in which access to the access-restricted spatial area is granted and in particular the physical access restriction in the form of the pair of doors 110b is opened. Otherwise (390—no), the system branches to step 375, and access is accordingly denied.

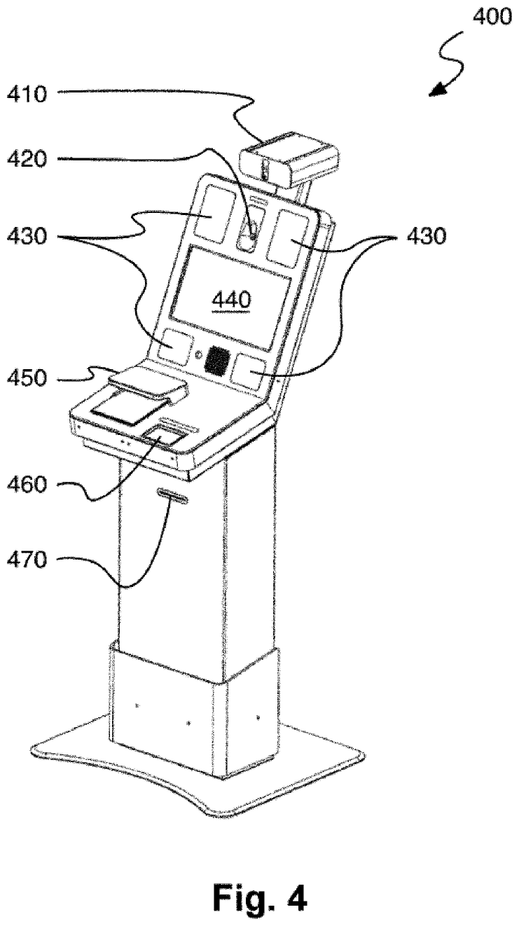

FIG. 4 illustrates a further exemplary embodiment 400 of a device for personal access control, which is in the form of a kiosk, as an alternative to FIG. 1. The personal access control takes place here in particular in that the person P authenticates himself at the kiosk and is subjected at the same time to a body temperature measurement. For this purpose, the device 400 has an IR image sensor 410, which has an integrated reference radiation source for its calibration, as illustrated in FIG. 2, for example. Furthermore, a VIS image sensor 420 and one or —as shown—multiple illumination elements 430 for illuminating the field of view of the image sensors 410 and 420 are provided. In order to avoid or reduce disruptive, planar light reflections on the eyes or glasses of the person P, polarization filters can be provided on the illumination elements. The device can also include various elements of a user interface, in particular for the purpose of authenticating the person P, in particular a display device 440—preferably embodied as a touch-sensitive screen (touchscreen)—an ID card reader 450, a fingerprint sensor 460, and/or a printer 470 for printing a ticket on which a code indicating whether access to the access-restricted spatial area is granted or denied is printed in dependence on the result of the authentication and the body temperature measurement. In addition, in particular in the case of access denial by the code, a reason for the access denial can also be indicated, for example failed authentication due to an invalid ID or ID recognized as forged or biometric features of the person P, or a body temperature that is too high.

While at least one exemplary embodiment has been described above, it is to be noted that a large number of variations thereto exist. It is also to be noted that the exemplary embodiments described only represent non-limiting examples, and are not intended to restrict the scope, the applicability, or the configuration of the devices and methods described herein. Rather, the preceding description will provide those skilled in the art with guidance for implementing at least one exemplary embodiment, wherein it is apparent that various changes in the operation and arrangement of elements described in an exemplary embodiment may be made without departing from the scope of the subject matter defined in the appended claims and its legal equivalents.

What is claimed is:

1. A method for access control of persons, comprising:
detecting by sensor a reference radiation in an infrared, IR, wavelength range, which was emitted by a thermal reference radiation source at a known reference temperature (T_{R}), using an IR image sensor;
calibrating the IR image sensor as a temperature sensor in relation to the detected reference radiation serving as a standard at the reference temperature (T_{R});
acquiring by image sensor at least an area section of a body surface of a person to be controlled in the infrared wavelength range by of the IR image sensor and generating thermal image data representing a thermal image of the area section acquired;
determining a body temperature (T_{K}) of the person assigned to the area section based on the thermal image data and taking into consideration the calibration;
granting or denying access of the person to an access-restricted spatial area in dependence on the determined body temperature.

2. The method of claim 1, further comprising:
acquiring by image sensor the at least one area section in the visible wavelength range and generating image data representing the image of the area section acquired; and
detecting at least one biometric feature of the person based on the image data; wherein the granting or denying of access for the person to the access-restricted spatial area additionally takes place in dependance on the at least one specific biometric feature.

3. The method of claim 2, further comprising:
identifying two or more partial areas in the area section based on the at least one biometric feature as respective images of specific respective body surface sections of the person (P);
assigning a respective local body temperature (T_{K}) of the person to each of these partial areas based on the thermal image data and taking into consideration the calibration;
comparing at least two of the respective local body temperatures to one another or to a respective assigned temperature standard for the respective body surface sections;
wherein the granting or denying of the access of the person to the access-restricted spatial area additionally takes place in dependence on whether the comparison result(s) meet(s) an access criterion assigned to the comparison(s).

4. The method of claim 1, wherein the body temperature (T_{K}) of the person assigned to the area section is determined based on the thermal image data and in consideration of the calibration in such a way that only the respective temperature values of one or more partial areas of the area section from the thermal image are selectively used for this purpose, in which the partial areas or their temperature values or both correspond to a predetermined selection criterion.

5. The method of claim 2, further comprising:
determining the image area proportion (F) within the image represented by the image data of the total area (A) of the image which images a predetermined selected body surface section of the person;
checking whether the image area proportion (F) meets an image area proportion criterion (R) specifying a minimum required image area; and
if according to the test the image area proportion (F) does not meet the image area proportion criterion (R), denying the access of the person to the access-restricted spatial area.

6. The method of claim 2, further comprising:
correcting the perspective of the image of the surface area represented by the image data before the at least one biometric feature of the person is detected based on the image that is then corrected in perspective.

7. The method of claim 1, wherein in case of a denial of access, one or more of the following reactions is triggered:
an audible or visual alarm;
physically blocking access to the access-restricted spatial area;
sending a signal or message to a predetermined recipient to notify the denial of access;
generating a physical access token having an encrypted message to a predetermined recipient notifying that access has been denied.

8. The method of claim 3,
wherein the body temperature (T_{K}) of the person assigned to the area section is determined based on the thermal image data and in consideration of the calibration in such a way that only the respective temperature values of one or more partial areas of the area section from the thermal image are selectively used for this purpose, in which the partial areas or their temperature values or both correspond to a predetermined selection criterion; and
the method further comprises:
determining the image area proportion (F) within the image represented by the image data of the total area (A) of the image which images a predetermined selected body surface section of the person;
checking whether the image area proportion (F) meets an image area proportion criterion (R) specifying a minimum required image area;
if according to the test the image area proportion (F) does not meet the image area proportion criterion (R), denying the access of the person to the access-restricted spatial are;
correcting the perspective of the image of the surface area represented by the image data before the at least one biometric feature of the person is detected based on the image that is then corrected in perspective,
wherein in case of a denial of access, one or more of the following reactions is triggered:
an audible or visual alarm;
physically blocking access to the access-restricted spatial area;
sending a signal or message to a predetermined recipient to notify the denial of access;
generating a physical access token having an encrypted message to a predetermined recipient notifying that access has been denied.

9. A device for access control of persons, comprising:
an IR image sensor for acquiring by image sensor radiation in an infrared, IR, wavelength range and for generating thermal image data representing a thermal image acquired;
a reference radiation source for emitting an at least partially infrared reference radiation at a known reference temperature (T_{R}) of the reference radiation source provided as a standard for calibrating the IR image sensor as a temperature sensor;
an access control device for signaling or effectuating a grant or denial of access of a person to an access-restricted spatial area; and
a controller, which is configured:
to carry out the calibration of the IR image sensor as a temperature sensor in relation to an acquired reference radiation used as a standard at the reference temperature (T_{R});
to determine a body temperature (T_{K}) for an area section of a body surface of the person to be controlled, represented by the thermal image data, taking into consideration the calibration; and
to activate the access control device in order to grant or deny the person access to the access-restricted spatial area in dependence on the determined body temperature (T_{K}).

10. The device of claim 9, further comprising:
a VIS image sensor for acquiring by image sensor the at least one area section in the visible wavelength range, VIS, and for generating the Image data representing the image data acquired.

11. The device of claim 9, further comprising:
a thermocouple for determining by sensor the reference temperature (T_{R}) of the reference radiation source.

12. The device of claim 9, wherein the IR image sensor or the VIS image sensor are configured so that their respective position, their orientation, or their focus are variably adjustable in order to be able to vary the image detail that can be acquired by the respective image sensor.

13. The device of claim 9, wherein:
the reference radiation source is arranged in the same housing as the IR image sensor;
the field of view of the IR image sensor has a partial field of view area that is located inside the housing and is not intended for the detection of IR radiation incident from outside the housing; and
a deflection mirror for IR radiation is arranged in the partial field of view area, which is configured to deflect reference radiation emitted by the reference radiation source into the field of view of the IR image sensor, in order to thus enable acquisition by sensor of the reference radiation by the IR image sensor in the partial field of view area.

14. The device of claim 9, wherein the access control device has a personnel airlock, in which access to the access-restricted spatial area is granted or denied in dependence on the determined body temperature (T_{K}).

15. The device of claim 14, wherein the reference radiation source is arranged at a first position on the personnel airlock and the IR image sensor is arranged at a second position, opposite the first position with respect to the interior of the personnel airlock, in such a way that the beam path of the reference radiation source is at least partially in the field of view of the IR image sensor such that it does not cross a spatial area provided for accommodating the person to be controlled in the personnel airlock.

16. The device of claim 9, wherein the access control device comprises a coding device for generating a coded access token, wherein the code indicates, in dependence on the determined body temperature (T_{K}), whether access to the access-restricted spatial area is granted or denied.

17. The device of claim 10, further comprising:
a thermocouple for determining by sensor the reference temperature (T_{R}) of the reference radiation source,
wherein the IR image sensor or the VIS image sensor are configured so that their respective position, their orientation, or their focus are variably adjustable in order to be able to vary the image detail that can be acquired by the respective image sensor,
the reference radiation source is arranged in the same housing as the IR image sensor;
the field of view of the IR image sensor has a partial field of view area that is located inside the housing and is not intended for the detection of IR radiation incident from outside the housing;
a deflection mirror for IR radiation is arranged in the partial field of view area, which is configured to deflect reference radiation emitted by the reference radiation source into the field of view of the IR image sensor, in order to thus enable acquisition by sensor of the reference radiation by the IR image sensor in the partial field of view area,
wherein the access control device has a personnel airlock, in which access to the access-restricted spatial area is granted or denied in dependence on the determined body temperature (T_{K}),
wherein the reference radiation source is arranged at a first position on the personnel airlock and the IR image sensor is arranged at a second position, opposite the first position with respect to the interior of the personnel airlock, in such a way that the beam path of the reference radiation source is at least partially in the field of view of the IR image sensor such that it does not cross a spatial area provided for accommodating the person to be controlled in the personnel airlock, and
wherein the access control device comprises a coding device for generating a coded access token, wherein the code indicates, in dependence on the determined body temperature (T_{K}), whether access to the access-restricted spatial area is granted or denied.
